(19) United States
(12) Patent Application Publication
(10) Pub. No.: US 2008/0278953 A1
(43) Pub. Date: Nov. 13, 2008

(54) Toggle Mount Assembly

(75) Inventor: Eric Haugaard, Kenosha, WI (US)

Correspondence Address: JANSSON SHUPE & MUNGER LTD., 245 MAIN STREET, RACINE, WI, 53403, US

(73) Assignee: RUUD LIGHTING, INC., Racine, WI (US)

(21) Appl. No.: 11/745,447

(22) Filed: May 7, 2007

(51) Int. Cl. F21V 21/00; F21V 15/00

(52) U.S. Cl. 362/365

(57) ABSTRACT

In an embodiment of an assembly for recessed mounting of a body, the body includes proximal and distal end and further includes as least one mounting point. The assembly includes a threaded shaft connected to body through the mounting point and capable of rotatable movement relative to the mounting point. A toggle having a first end including a threaded interior and a second end that is a free end is screwed onto the threaded shaft and rotatable around it. A spring is mounted around the threaded shaft between the mounting point of the body and the first end of the toggle, whereby the spring biases the toggle toward the distal end of the body.

### FIELD OF THE INVENTION

This invention is related generally to mounting a recessed body within a wall or ceiling and, more particularly, to assemblies for mounting the body securely to the wall or ceiling once the body in moved into position.

### BACKGROUND OF THE INVENTION

In the field of lighting and in construction in general, junction boxes and light fixtures are often mounted in a recessed position to hide the structure of the body being mounted and avoid clutter on the wall or ceiling. The body being secured must be held in place using only the wall or ceiling it is being mounted to and is often done in extremely low light situations or where the installation mechanics cannot be seen at all. In such settings, easy of insertion and precise workings of installation devices are of paramount importance.

Many methods of installation have been developed to secure recessed mounted bodies. For example, U.S. Pat. No. 6,095,660 to Moriyama et al. discloses equipment for ceiling mounting a light fixture. The equipment for mounting in Moriyama includes a plurality of lamp casing stopping mechanisms secured on the outside of the lamp casing. Each lamp casing stopping mechanism includes a projected piece that is rotated into position and lowered by continuing to turn a threaded shaft. The shaft is held in place in relation to the light fixture by a rubber ring around the shaft. These rubber rings are subject to degradation and easily susceptible to being destroyed by too mush torque during installation.

In U.S. Pat. No. 6,752,520 to Vemusset et al., a fixture support for a recessed mounting luminaire is disclosed. This complex method includes a rod that moves a separate locking lug out of stored position and into a deployed position through a contact with an abutment defining an abutment zone. When the lug is moved, a spring acts on the lug and pushes the lug into contact with the ceiling mounting the fixture. This support utilizes several different moving parts and does not allow for easy removal once the support is deployed.

While a vast array of mounting and supporting structures have been developed, a need exists for an improved device for recessed mounting that is simple to use yet highly precise in its workings.

### OBJECTS OF THE INVENTION

It is an object of the invention to provide an assembly for recessed mounting of a body overcoming some of the problems and shortcomings of the prior art, including those referred to above.

Another object of the invention is to provide an assembly for recessed mounting of a body keeps the toggles secured in position prior to and after installation.

Another object of the invention is to provide an assembly for recessed mounting of a body that allows easy installation into tight tolerance openings.

Another object of the invention is to provide a light fixture support assembly that prevents the assembly from being damaged during installation.

How these and other objects are accomplished will become apparent from the following descriptions and the drawings.

### SUMMARY OF THE INVENTION

In an embodiment of an assembly for recessed mounting of a body, the body includes proximal and distal end and further includes as least one mounting point. The assembly includes a threaded shaft connected to body through the mounting point and capable of rotatable movement relative to the mounting point. A toggle having a first end including a threaded interior and a second end that is a free end is screwed onto the threaded shaft and rotatable around it. A spring is mounted around the threaded shaft between the mounting point of the body and the first end of the toggle, whereby the spring biases the toggle toward the distal end of the body.

In another embodiment of an assembly for recessed mounting of a body the mounting point is a hole at the proximal end of the body.

In a further embodiment of an assembly for recessed mounting of a body the threaded shaft is a bolt with a head on a distal side of the hole.

In a yet another embodiment, the assembly for recessed mounting of a body further includes a jam nut assembly connected to the bolt opposite the head.

In a still further embodiment, the assembly for recessed mounting of a body further includes a plurality of mounting points and a plurality of assemblies.

In different embodiment, the assembly for recessed mounting of a body includes a top wall at the distal end of the body and a side wall connected to the top wall that defines an interior portion. The body further includes a plurality of indentations of the sidewall into the exterior portions, wherein each indentation defines a of recesses. Each assembly and corresponding mounting point are arranged whereby the toggle can be moved from a stowed position wherein the toggle is within the recess to a deployed position wherein the toggle is extending outward from the sidewall of the body.

In another embodiment, the assembly for recessed mounting of a body further includes a stopping mechanism for stopping the rotation of the toggle when it reaches the deployed position. In a further embodiment, the stopping mechanism is a extension from the first end of the toggle that comes into contact with the indentation of the side wall when the toggle is moved into the deployed position.

In yet another embodiment, the toggle further includes a lever arm extending from the free end. The lever arm includes a first end closest to the distal end of the body and a second end extending from the toggle toward the proximal end of the body, wherein the second end includes a crimping structure.

In further embodiments, the assembly for recessed mounting of a body includes a body having a seal around an outer edge of the interior, wherein the heads of the bolts are disposed on a interior side of the seal. In other embodiments, the body further includes a lip at the proximal end extending outwardly from the body opposite the interior and wherein the seal is around the lip.

### BRIEF DESCRIPTION OF THE DRAWINGS

FIG. 1 is a perspective view of a light fixture with a preferred embodiment of a toggle mount assembly.

FIG. 2 is a top plan view of the light fixture of FIG. 1.

FIG. 3 is a bottom plan view of the light fixture of FIG. 1.

FIG. 4 is a top plan view of the toggle assembly of FIG. 1.

FIG. 5 is side view of the toggle assembly of FIG. 1.

FIG. 6 is a sectional view of the light fixture of FIG. 2 taken along the line 1-1.

FIG. 7 is a side view of the light fixture of FIG. 1 with the toggle mount assemblies in the stowed position.

FIG. 8 is a side view of the light fixture of FIG. 1 with the toggle mount assemblies in the deployed position.

### DETAILED DESCRIPTION OF THE PREFERRED EMBODIMENTS

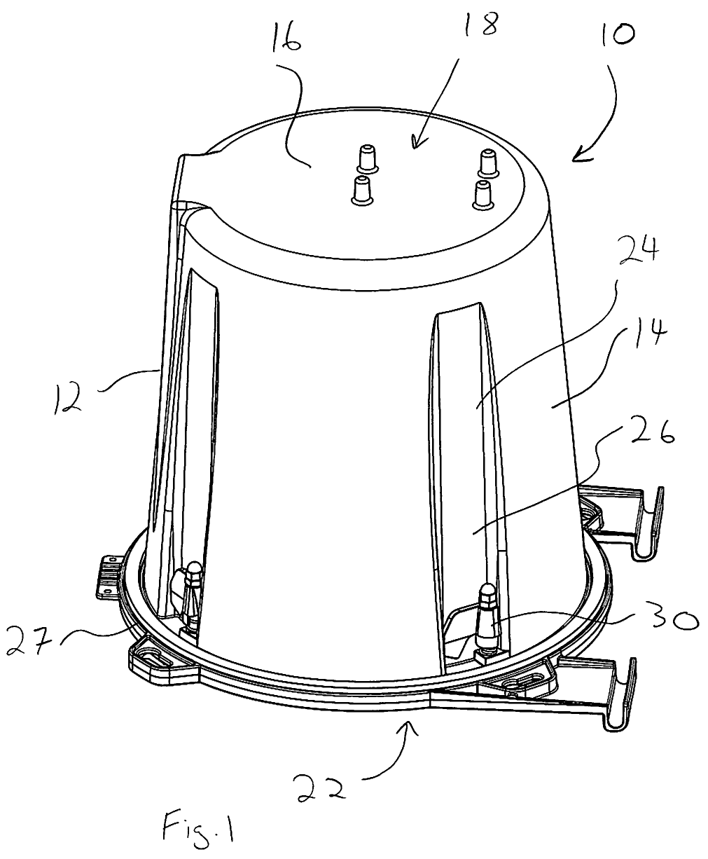

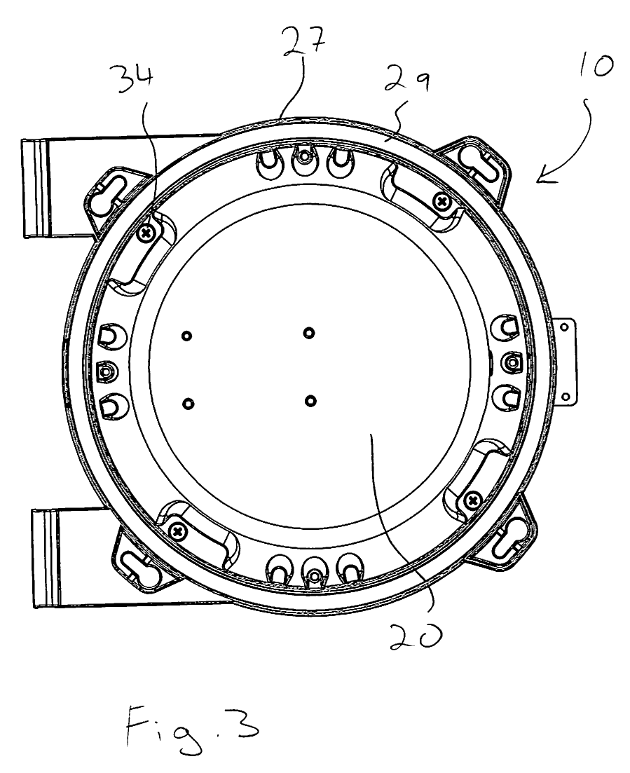

FIG. 1 illustrates a light fixture 10 utilizing a plurality of a preferred embodiment of a toggle mount assembly 30. The light fixture 10 further includes a body 12. The body 12 includes a substantially circular side wall 14. The circular shape of the side wall 14 is preferable as it make it easier to insert the fixture 10 into a circular ceiling hole when it is to be mounted. A top wall 16 is disposed at a distal end 18 of the fixture 10 and the top wall 16 and side wall 14 together define an interior 20 of the fixture 10 that is open at a proximal end 22 as seen in FIG. 3.

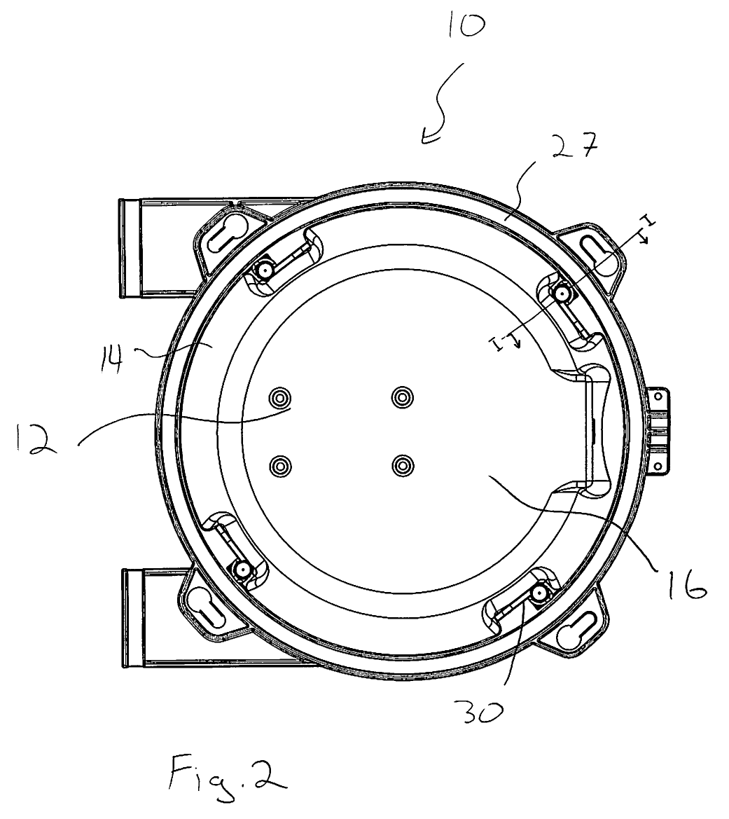

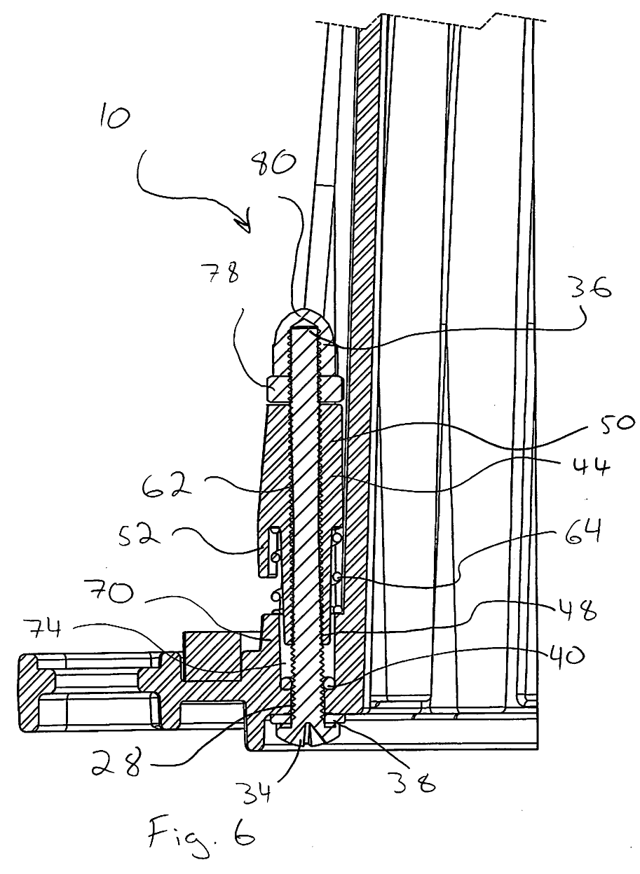

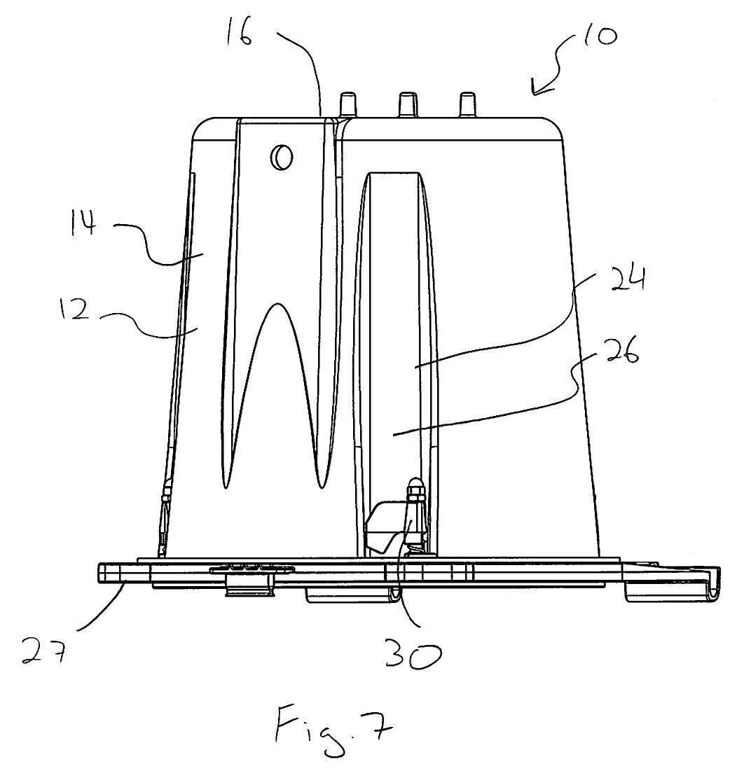

Turning now to FIG. 2, the body 12 further includes a plurality of recesses 24 around the outside of the body 12 which are defined by indentations 26 into the side wall 14. These recesses 24 are preferably spread evenly around the circumference of the body 12 and generally are equal in number to the toggle mount assemblies 30. The toggle mount assemblies 30 are mounted within the recesses 24 and mounted on the body 12 through a plurality of mounting points 28 which are holes within the recesses 24 at the proximal end 22 of the fixture 10 as seen in FIG. 6. The body 12 also includes a lip 27 extending from the side wall 14 at the proximal end 22 of the fixture 10. As seen in FIG. 3, this lip 27 includes an outer seal 29 extending around proximal end of the interior 20. This seal is useful if the fixture includes a cover (not shown) to close this open end of the fixture 10.

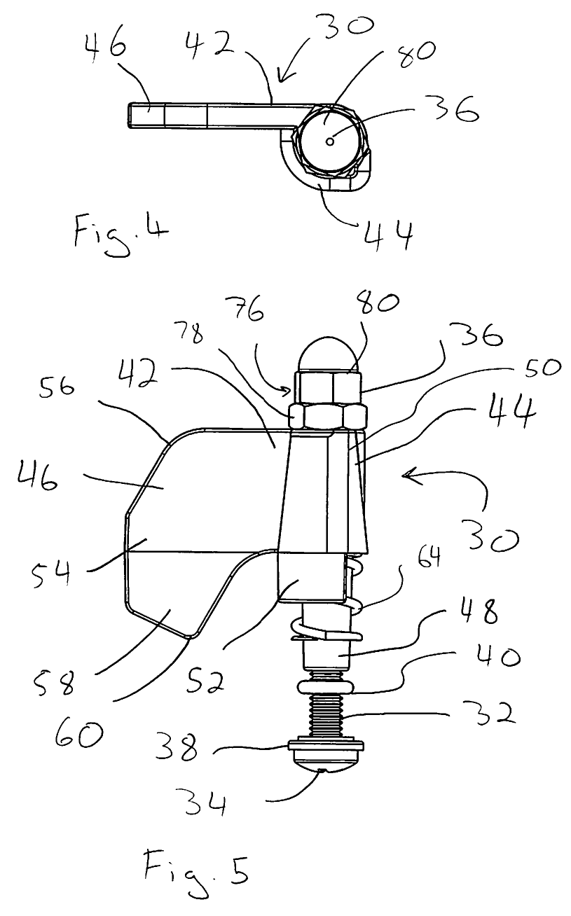

Referring now to FIGS. 4-6, each of the toggle mount assemblies 30 are comprised of several smaller parts. A thread shaft 32, preferably a screw or in this preferred embodiment, a bolt, serves as the base for the assembly 30. The bolt 32 includes a head end 34 and a free end 36. The free end 36 of the bolt 32 is inserted through the mounting point 28, which is preferably not threaded, whereby the head end 34 is closest to the proximal end 22 of the fixture 10. A sealing washer 38 may be added between the head end 34 of the bolt and the mounting point 28 which is preferably located inside of the seal 29 on the lip 27.

In order to help keep moisture from the inside of the fixture 10 an O-ring 40 is optionally located around the bolt 32 on the distal end of the mounting point 28. In this preferred embodiment, the mounting point 28 is surrounded a ridge 70 which has an upper edge 72 defines a channel 74 that is wider than the mounting point 28 to accommodate the O-ring 40.

A toggle 42 forms the next part of the assembly 30. The toggle 42 is preferably one piece and includes a first end 44 around the bolt 32 and a second end 46 which is free and extends away from the bolt 32. The first end 44 includes a lower portion 48 which is dimensioned to fit inside the channel 74. The toggle 42 further includes a upper portion 50 which wider than the channel 74. The toggle 42 also includes a stopping mechanism 52 which in this preferred embodiment is a flange extending from the upper portion 50 toward the proximal end 22 of the fixture 10.

The second end 46 of the toggle 42 in this preferred embodiment is a generally L-shaped with a lever arm 54 extending from the second end 46 of the toggle 42 toward the proximal end of the fixture 10. This lever arm 54 includes a first end 56 closest to the distal end of the fixture 10 and a second end 58 closest to the proximal end of the fixture 10. In this preferred embodiment the second end 58 of the lever arm 54 forms a pointed crimping structure 60. Finally, the toggle 42 includes a threaded interior 62 that aligns with the threaded bolt 32 and allows the toggle 42 to rotate in relation to movement of the bolt 32.

A spring 64 fits around the bolt 32 and rests on the upper edge 72 of the channel 70 between the mounting point 28 and the upper portion 50 of the toggle 42. The spring 64 is preferably a snug fit around the lower portion 48 of the toggle 42 that minimizes free rotational movement of the toggle 42 without torque from a hand tool being applied to the bolt 32. The bolt 32 is topped off at is distal end by a jam nut assembly 76. The jam nut assembly 76 is comprised of a jam nut 78 capped off by an acorn net 80. Other know means of capping the bolt 32 could be utilized, however this jam nut assembly, as described further below, offers the safest method of avoiding losing the toggle 42 if improperly installed.

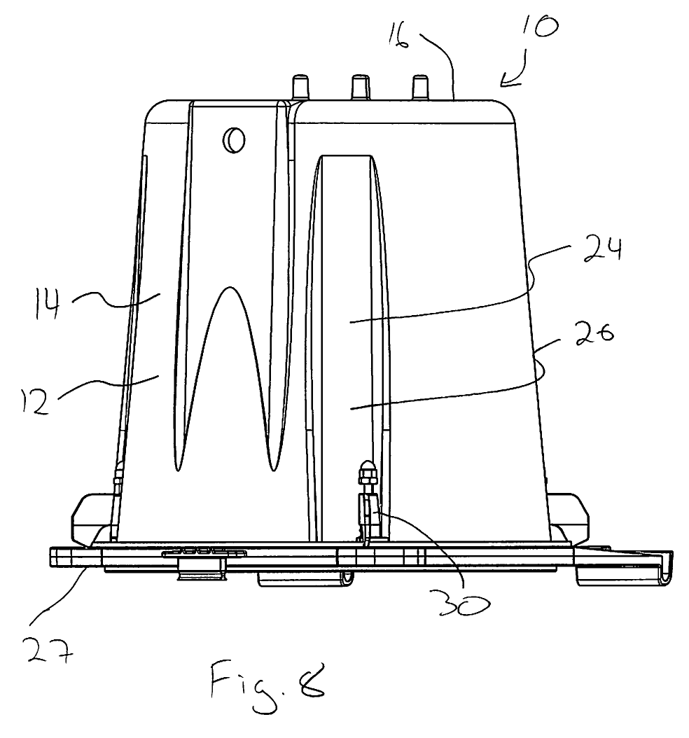

In operation the fixture 10 is placed into a pre-cut mounting hole (not shown) distal end 18 first. When the fixture 10 is installed the toggle mount assemblies 30 are completely within the recesses 24 to allow the fixture 10 to easily slide into place. This position is known as the stowed position and is best seen in FIGS. 2 and 7. The fixture 10 is lifted until the lip 27 comes in contact with the ceiling (not shown). A hand tool is then utilized to turn each of the bolts 32 to tighten the toggles 42. As the bolt 32 are turned the toggle 42 turns out of the stowed position until the flange 52 comes in contact with the indentation 26 and the toggle 42 is then in the deployed position as shown in FIG. 8 with the second end 46 of the toggle 42 extending outwardly from, and preferably perpendicularly from, the side wall 14. As the bolt 32 continues to turn the threads of the bolt 32 and the threaded interior 62 of the toggle 42 interact to pull the toggle 42 down. This compresses the spring 60 and pulls the lower portion 48 of the toggle into the channel 74. This downward motion continues until the crimping structure 60 comes in contact with the ceiling.

The spring 64 ensures that the toggle 42 remains as far away from the proximal end 22 of the fixture 10 as possible until the toggle 42 is deployed. During installation, the crimping structure 60 acts as the point of first contact with the ceiling for the toggle 42, and, if the ceiling is thick, the pointed nature of the crimping structure 60 can help compress many building materials and ensure the best possible fit for the fixture 10. The jam nut assembly 76 helps to ensure that the toggle remains usable even if the bolt 32 is turned to loosen the toggle 42 while the toggle 42 is in the stowed position by being able to absorb torque from the twisting of the bolt if turned improperly during installation.

While the principles of the invention have been shown and described in connection with specific embodiments, it is to be understood that such embodiments are by way of example and are not limiting.

1. An assembly for recessed mounting of a body wherein the body includes proximal and distal end and further includes as least one mounting point, the assembly comprising:
a threaded shaft connected to body through the mounting point and capable of rotatable movement relative to the mounting point;
a toggle having a first end including a threaded interior and a second end that is a free end, the threaded interior being screwed onto the threaded shaft and rotatable around the shaft;
a spring mounted around the threaded shaft between the mounting point of the body and the first end of the toggle, whereby the spring biases the toggle toward the distal end of the body.

2. The assembly for recessed mounting of a body of claim 1 wherein the mounting point is a hole at the proximal end of the body.

3. The assembly for recessed mounting of a body of claim 2 wherein the threaded shaft is a bolt with a head on a distal side of the hole.

4. The assembly for recessed mounting of a body of claim 3 further including a jam nut assembly connected to the bolt opposite the head.

5. The assembly for recessed mounting of a body of claim 4 further including a plurality of mounting points and a plurality of assemblies.

6. The assembly for recessed mounting of a body of claim 5 wherein the body includes a top wall at the distal end of the body and a side wall connected to the top wall and defining an interior portion, the body further including a plurality of indentations of the sidewall corresponding to the number of assemblies, each indentation defining a recesses,
each assembly and corresponding mounting point arranged whereby the toggle can be moved from a stowed position wherein the toggle is within the recess to a deployed position wherein the toggle is extending outward from the sidewall of the body.

7. The assembly for recessed mounting of a body of claim 6 further comprising a stopping mechanism for stopping the rotation of the toggle when it reaches the deployed position.

8. The assembly for recessed mounting of a body of claim 7 wherein the stopping mechanism is a extension from the first end of the toggle that comes into contact with the indentation of the side wall when the toggle is moved into the deployed position.

9. The assembly for recessed mounting of a body of claim 8 wherein the toggle further includes a lever arm extending from the free end.

10. The assembly for recessed mounting of a body of claim 9 wherein the lever arm includes a first end closest to the distal end of the body and a second end extending from the toggle toward the proximal end of the body, wherein the second end includes a crimping structure.

11. The assembly for recessed mounting of a body of claim 9 wherein the body includes a seal around an outer edge of the interior, wherein the heads of the bolts are disposed on a interior side of the seal.

12. The assembly for recessed mounting of a body of claim 11 wherein the body further includes a lip at the proximal end extending outwardly from the body opposite the interior and wherein the seal is around the lip.
